(19) United States
(12) Patent Application Publication
(10) Pub. No.: US 2014/0014271 A1
(43) Pub. Date: Jan. 16, 2014

(54) DEVICE FOR PRODUCING TUBULAR STRUCTURES

(71) Applicant: Rene Weber, Steg (CH)

(72) Inventor: Rene Weber, Steg (CH)

(73) Assignee: PACKSYS GLOBAL (SWITZERLAND) LTD., Rueti (CH)

(21) Appl. No.: 14/007,139

(22) PCT Filed: Feb. 1, 2012
(86) PCT No.: PCT/EP2012/051674

§ 371 Date: Sep. 24, 2013

(30) Foreign Application Priority Data
Mar. 24, 2011 (DE) 10 2011 001 546.9
Mar. 24, 2011 (DE) 10 2011 001 547.7
Jun. 10, 2011 (DE) 20 2011 050 417.4
Jun. 10, 2011 (DE) 20 2011 050 418.2
Oct. 14, 2011 (EP) 11185239.8

(51) Int. Cl. B29D 23/00

(52) U.S. Cl. CPC B29D 23/00
USPC 156/475

(57) ABSTRACT

A device for producing tubular structures for packaging tubes, comprising an elongate mandrel (3) extending axially, around which a substrate web can be subjected to a forming process to produce a tubular moulding (4), where, within the mandrel (3), there are a plurality of gas-outlet apertures (15) to which compressed gas can be applied to produce a gas cushion, in particular an air cushion, between the mandrel (3) and the tubular moulding (4), and where there are welding means for welding the tubular moulding, and where, with the aid of means (19) arranged radially adjacent to the mandrel (3) and capable of providing a combination of pressure-application and conveying, the tubular moulding (4) can be forced radially inwards in a direction towards a mandrel surface (16) which belongs to the mandrel (3) and which is convexly curved in a circumferential direction, and the tubular moulding (4) can be transported in a direction of the longitudinal direction of the mandrel (3) by virtue of a frictional effect between the means and the tubular moulding (4).

### BACKGROUND OF THE INVENTION

The invention relates to a device for producing tubular structures for packaging tubes, comprising an elongated mandrel extending in an axial direction, around which a substrate web can be shaped to produce a tubular shape, wherein a plurality of gas outlet openings for generating an air cushion between the mandrel and the tubular shape are provided in the mandrel. The invention also relates to a method for producing tubular structures for packaging tubes.

A device for producing tubular structures is described in general in DE 41 21 427 C2. An endless substrate web, usually a laminate, in particular a plastic laminate, which depending on the application can comprise a metal foil or a metallisation layer, is shaped around an elongated cylindrical mandrel, in such a way that an overlapping region is formed between two longitudinal edges, wherein the overlapping region for producing the tubular shape with suitable welding means, in particular a high-frequency welding device, is welded and is transported onward in the direction of the longitudinal extension of the mandrel. A cutting device is usually provided spaced apart from the welding device in the axial direction, by means of which cutting device the produced tubular strand is cut up into tubular structures of desired axial extension. With known devices for producing tubular structures, a cooling device is usually provided—in the transport direction of the substrate web or the tubular shape—downstream of the welding means, along which cooling device the tubular structure slides and by means of which the weld seam produced with the aid of the welding means is cooled radially from the exterior. A considerable space requirement for the overall device thus results.

A further problem arising in practice in the production of packaging tubes with the devices described above consists in the need to improve the roundness of the tubular structure.

It is known from practice to provide an air outlet hole with a diameter of several millimetres on the mandrel respectively at two positions facing away from one another through 180°, wherein the two air outlet holes are disposed not directly in the lateral cylindrical surface, i.e. not on the curved mandrel surface, but rather on a lateral, plane flattened portion located radially inside the cylindrical enveloping contour of the mandrel. Compressed air exits from the air outlet holes, as a result of which friction between the tubular shape and the mandrel in a region directly adjacent to the two holes is intended to be reduced.

Depending on the selection of the substrate material, considerable friction occurs despite the air outlet holes between the tubular shape and the mandrel and possibly even abrasion, which on the one hand leads to contamination of the tubular pipe interior with abrasion dust and which on the other hand necessitates regular cleaning of the mandrel. Moreover, undesired scratches in the tubular pipe can occur. This is due, amongst other things, to the fact that the tubular shape is subjected, with the aid of concave-contoured rollers or straps, to forces acting inwards in the radial direction towards the cylindrical mandrel surface and is transported in the transport direction due to the friction effect between the rollers or the straps and the tubular shape.

The contamination of the tubular structures with abrasion dust is especially problematic in the production of tubes for the pharmaceutical industry, because here a high degree of purity is required on the one hand and, on the other hand, use is usually made of materials with a high friction coefficient.

A device for the extrusion of very thin-walled and windable PET or PVC film tubes is known from US publication U.S. Pat. No. 2,987,765 which lies outside the field. In contrast with production devices for tubular structures, which operate with cold laminate substrates, heated and therefore fluid PET or PVC is extruded through an extrusion nozzle in the case of the known extrusion device. A hot film tube arises, which is conveyed over a mandrel which is constituted by a porous material. Compressed air is blown out through the pores in the mandrel surface in order to regulate the temperature of the molten film and to adjust the size of the film tube. In contrast with production devices for tubular structures, the known extrusion device for the production of film tubes does not comprise any moulding means which press the hot extrusion products in the direction of the mandrel, so that major problems with friction are not to be unexpected in the case of the known film extrusion device. The air cushion generated with the known device has a total circumferential thickness (radial extension) between 75 μm and 500 μm. The volume flow per unit area with the known device amounts to 150 cm³/min×cm². The air pressure of the generated air cushion amounts to 0.3 bar. A certain amount of floating of the tube on the mandrel is of no consequence with the known extrusion device, but has to be avoided in the case of production devices for tubular structures.

In the case of the known extrusion device, a traction device alone is provided as a transport mechanism for the transport of the tube, with which tractive forces are applied to the tube and the latter is wound onto a roll. Such a procedure would lead to destruction of the products in the case of tubular structure production.

Proceeding from the aforementioned prior art, the problem underlying the invention is to provide a device with which scratches in the tubular pipe and abrasive phenomena are reduced, preferably avoided, in order to minimise contamination of the tube pipe with dust and to increase the maintenance or cleaning intervals for the mandrel. Furthermore, the problem consists in providing a correspondingly improved method.

A higher piece number of tubular structures per unit of time should preferably be able to be produced with the device. In particular, the device should be suitable for the production of tubes for the pharmaceutical industry. The spatial requirement of the device should preferably be minimised. Even more preferably, the roundness of the tubular structures should be improved.

### SUMMARY OF THE INVENTION

The problem is solved with the features of the device and with the features of the method of the present invention.

In the present technical field of producing flexible, i.e. non-rigid, tubular structures for packaging tubes, in particular made of a laminate material, there is the particular problem that the flexible substrate web wraps as a tubular shape around the mandrel through at least 360° as soon as the substrate web has been shaped to form a tubular shape, wherein two longitudinal edge regions of the substrate web come into contact. “Tubular shape” is understood to mean the state in which the wrap angle amounts to at least 360°—welding does not yet have to have taken place. As a substrate, use is preferably made of a laminate, in particular comprising at least one barrier layer. The laminate can comprise exclusively plastic layers. It is also possible for at least one non-plastic layer, for example of aluminium or SiOₓ, to be provided apart from a plastic layer. The substrate used preferably has a thickness extension from the value range between 75 μm and 500 μm, preferably between 150 μm and 400 μm.

This tubular shape does not readily slide along the mandrel, but is subjected to a force acting radially from the outside inwards with the aid of suitable means, in order amongst other things to generate adequate static friction between the means and the tubular shape, which ensures that the tubular shape is transported with the aid of the means in the axial direction, i.e. in the direction of the longitudinal extension of the mandrel. At the same time, floating or rotation of the tubular shape on the mandrel thus made possible is prevented by the pressure-application means. Floating and in particular the aforementioned rotation of the tubular shape on the mandrel should without fail be avoided, because otherwise the weld seam required, unlike extrusion processes, can no longer be formed, since the overlapping or abutting region of the substrate longitudinal edges no longer runs in the welding region, i.e. beneath the welding means. A gas cushion with a large radial extension would increase the tendency towards floating or rotation. Due to the fact that the flexible substrate web is subjected directly to a mechanical force acting radially outside and is pressed radially inwards, the friction conditions between the tubular shape and the mandrel are increased dramatically. This effect is further intensified by the fact that the substrate web forms a tubular shape and the longitudinal edge regions of the tubular shape are usually subjected to forces in mutually opposite circumferential directions with the aid of the means in order to enable the welding process. The friction effect is additionally increased by the wrapping. In order to avoid the floating or rotation of the tubular shape, use is made of the aforementioned pressure-application means, in particular in the form of at least one forming strap, said means simultaneously ensuring that the gas cushion has locally an only small radial extension, in particular between 3 μm and 50 μm, preferably between 5 μm and 35 μm, still more preferably between 5 μm and 25 μm. In other words, provision is made according to a development to counteract floating or rotation of the tubular shape by generating a gas cushion inhomogeneous relative to its radial extension. In other words, the pressure-application means act differently locally, so that there are regions of differing radial extension in relation to the gas cushion, wherein an only small radial extension of the gas cushion in the aforementioned value range is preferably generated in at least one region, more preferably in a plurality of regions.

The idea underlying the invention is to produce a preferably circumferentially closed gas cushion between the substrate web to be shaped into a tube and the mandrel, said gas cushion having a comparatively large axial extension and preferably also a larger circumferential extension than the gas cushion previously generated by two individual, comparatively large air outlet holes, wherein the mandrel is constituted at least in sections by microporous and/or nanoporous material and thus provides a multiplicity of small gas outlet openings in the form of pores through which the compressed gas can flow out. A compressed gas source connected to the mandrel is of course provided for the purpose of applying compressed gas to the gas outlet openings. In contrast with the prior art, therefore, a multiplicity of extremely small gas outlet openings are provided, which are located directly in the curved mandrel surface. The spreading and slide effect of the gas cushion according to the invention is thus considerably improved.

According to the invention, provision is made to provide the mandrel, at least in sections, i.e. at least in a surface section, with a porous material, preferably to constitute the mandrel at least in sections by said porous material, wherein the gas outlet openings are understood to mean the pores of the porous, preferably foamed material in the case where porous material is provided.

Very particularly preferably, the gas outlet openings are constituted as pores open to the exterior in a preferably metallic or ceramic, porous, in particular microporous, material. This material can for example be a sintered material or a material produced by thermal spraying or a metal foam.

It has proved to be particularly expedient, as mentioned above, if at least some of the gas outlet openings, preferably all the gas openings, are formed by (micro- and/or nano-scale) pores in a microporous material, wherein, in the case where a microporous material is provided, it is for example a sintered material or a porous material produced by thermal spraying or a foamed material. Compared to mechanically produced gas outlet openings, the pores of such a microporous material have much smaller cross-sections, so that a finely distributed air cushion can be generated. The average pore diameter (average cross-section) in the case of the microporous material is preferably from a value range between 0.05 μm and 2 mm, preferably between 0.1 μm and 1 mm, preferably between 1 μm and 500 μm, still more preferably between 1 μm and 100 μm.

In the case where use is made of nanoporous material, the latter is preferably constituted such that gas-permeable intermediate spaces (pores) are formed in this nanomaterial, the average cross-sections whereof lie in the range between 1 and 100 nm. In particular, the nanomaterial has an average molecular size (average molecular diameter) between 1 and 100 nm, preferably less than or equal to 15 nm. As already indicated, the nanomaterial is preferably a metallic material, wherein particularly good nanoporous properties can be achieved on the basis of nickel. In addition or alternatively, aluminium oxides, silicon oxides, zirconium oxides, titanium oxides or mixtures thereof can be used as nanomaterials.

The previously described gas outlet openings in the form of pores thus ensure that the friction between the substrate, constituted in particular as a laminate, and the mandrel is minimised. The generated gas cushion thus counteracts the contact pressure of the combined pressure-application and conveying means, in particular in the form of at least one forming strap and/or a pressure-application roller. The system is preferably constituted such that a notable pressure build-up of the gas cushion only results or only arises when the substrate approaches the mandrel to within a few microns, in particular from a value range between 3 μm and 50 μm, in particular between 5 μm and 40 μm, still more preferably between 5 μm and 25 μm. Due to the effect of the pressure-application means in particular, this does not take place around the whole circumference, but is limited to partial areas. Preferred gas volume flows between approx. 1 cm³ and 50 cm³/min×cm² related to the porous mandrel surface result. As a result of the effect of the pressure-application means and the at least locally very small distance preferably between 5 μm and 25 μm thus obtained between the substrate and the mandrel, the pressure of the gas cushion rises locally, i.e. in regions at a small distance, to a value from the value range between approx. 1 bar and 6 bar. This pressure is necessary in order to be able to apply a corresponding counter-force against the pressing pressure-application means, in particular the forming strap. In order to guarantee this, the compressed gas supply must be correspondingly designed, or more precisely adapted to the porosity of the mandrel material. The nature and thickness of the substrate material is constituted such that spreading of the substrate or the tubular shape clamped between the welding strips of the welding device does not occur.

In order to form the gas outlet openings, provision is made according to the invention to constitute the mandrel, at least in sections, by open-pore metal foam, wherein the metal foam can for example be constituted as aluminium foam. It is also possible to combine the metal foam with ceramic material to increase the stability. It is also feasible for the metal foam to form a kind of support for further microporous and/or nanoporous material, wherein the further material then forming the mandrel surfaces can be sintered or produced by thermal spraying or by a foaming with a propellant.

It is very particularly preferable if the pore size of the pores of the microporous material, in particular of the metal foam, diminishes towards the mandrel surface.

In addition or as an alternative to microporous material, nanoporous material can be provided to form the gas outlet openings, it being particularly preferable if an aforementioned microporous material serves as a support for the nanoporous material then forming a kind of coating. The molecular size of the nanomaterial used preferably amounts to between 0.5 nm and 500 nm, very particularly preferably between 0.5 nm and 200 nm. The nanomaterial is preferably a metallic material, for example based on nickel, or zirconium oxide, or titanium oxide, or silicon oxide or aluminium oxide.

In principle, it is possible for the porous, in particular the microporous and/or the nanoporous material to be constituted self-supporting, i.e. to create a sufficient thickness extension (radial extension) such that no supporting structure is required in the interior. Preference is however given to an embodiment in which the porous, in particular foamed material is deposited on a supporting structure. In this case, a small thickness extension of the porous, in particular microporous and/or nanoporous material can be produced, preferably from a thickness extension range (radial extension range) between 0.5 mm and 10 mm, preferably between 1 mm and 5 mm. A supporting structure for the porous material is preferably constituted such that a uniform air distribution is ensured in the axial and/or in the circumferential direction in the interior of the mandrel.

The tubular structure is preferably cut to size in a region after the mandrel. The device is preferably free from means for winding the product onto a roll.

It has proved to be particularly advantageous if the average pore size, i.e. the arithmetical mean of the pore size, is selected from a value range between approx. 0.05 μm and 2 mm, preferably between 0.1 μm and 2 mm. In principle, different materials come into consideration for the material selection for forming the porous material or the porous material section, thus for example a metal foam, a ceramic foam or a plastic foam. The material should be selected such that it meets the strength requirements.

This in turn leads to less dust contamination of the tubular pipe interior, to smoother internal surfaces and also to the possibility of using substrate material having a comparatively high friction coefficient which hitherto could only be used with difficulty or could not be used, in particular for the pharmaceutical industry. The gas cushion is preferably dimensioned such that the substrate shaped to form the tubular shape slides completely on the air cushion, in particular up to the axial end of the mandrel, as a result of which friction effects and therefore abrasive effects can be avoided at least for the most part.

It is particularly expedient if the gas outlet openings are disposed, at least in part, not in flat portions, grooves, etc., i.e. inside or set back from an, in particular, cylindrical enveloping contour of the mandrel, but rather directly in the lateral cylindrical surface of the mandrel, in order to enable a more uniform air cushion formation.

With the aid of the compressed gas acting on the tubular shape from radially inwards, a weld seam produced with the aid of the welding means and/or the tubular shape, preferably previously heated, as will be explained further below, can be cooled, so that separate cooling devices usually acting from radially outside in the prior art for the purpose of cooling the welding seam can be dispensed with. The provision of the multiplicity of gas outlet openings according to the invention thus leads to a device which is characterised by a smaller space requirement due to an additional cooling device for cooling the welding seam being dispensed with.

The average diameter of the gas outlet openings is particularly preferably selected from a value range between 0.05 μm and 2 mm, preferably between 0.1 μm and 1 mm, preferably between 1 μm and 100 μm, still more preferably between 1 μm and 10 μm. This small diameter of the gas outlet openings can be guaranteed in particular if the gas outlet openings, as will be explained in greater detail below, are formed by pores in a microporous and/or nanoporous material. Especially when the gas outlet openings are formed at least in part by a nanomaterial structure, the average pore diameter can be much smaller and preferably amounts to less than 1 μm.

The invention has recognised that, for the formation of a gas cushion, in particular an air cushion, markedly improved compared to the prior art, it is advantageous to provide as large a number of gas outlet openings as possible, in particular for compressed air, in the mandrel, through which compressed gas, in particular compressed air, can flow radially from the inside outwards. Very particularly preferably, at least ten, preferably at least 50, or at least 100, or at least 150, or more than 200, or more than 300, or more than 400, or more than 500, or preferably more than 1000 or several thousand gas outlet openings are provided. Gas outlet openings are preferably located over an axial extension of at least 20%, preferably at least 30%, still more preferably at least 50% of the total axial extension of the mandrel, in order to achieve a good gas cushion over a long section.

It is particularly expedient if at least ten, preferably a least 20, preferably at least 50, still more preferably at least 100, very particularly preferably at least 150, or even more preferably at least 200 gas outlet openings or more than a thousand gas outlet openings are disposed at different axial positions along the axial extension of the mandrel.

In addition or as an alternative, it is preferable if at least ten, preferably at least 20, preferably at least 50, still more preferably at least 100 or at least 500 or at least 1000 gas outlet openings are disposed at different circumferential positions thanks to the circumferential extension of the mandrel.

Particularly good air cushion properties are achieved if, in at least one surface section of the mandrel, at least 5, preferably at least 10, particularly preferably at least 15, more preferably at least 20, still more preferably at least 50, 100, 150, 200, 1000, 2000 or 5000 gas outlet openings are provided per cm² of mandrel surface.

It is very particularly preferable if the welding means are welding means which comprise at least one welding strip accommodated in a longitudinal groove of the mandrel, said welding strip moving together with the substrate. A welding region of the substrate is preferably accommodated sandwich-like between this so-called inner welding strip and a welding strip acting radially on the outside, wherein the heating takes place for example with a high-frequency source (HF source). If need be, an additional HF source can be provided inside the mandrel in addition to or as an alternative to an HF source disposed outside the mandrel.

A variant of embodiment is particularly expedient, wherein at least one gas discharge channel is provided, with which the gas, in particular air, exiting through the gas outlet openings can be carried away, in particular in the axial direction, preferably in order to avoid undesired swelling of the welded tubular shape. A possibility exists of providing at the outer periphery of the mandrel at least one groove (gas discharge groove) preferably running in the axial direction, in which the gas can be transported away, i.e. can foam away.

A plurality of such grooves, in particular a plurality of grooves spaced apart in the circumferential direction, are preferably provided. In addition or as an alternative to the provision of grooves in the external mandrel surface, it is possible to provide in the mandrel at least one air discharge opening, preferably a plurality of air discharge openings, which lead to at least one gas discharge channel in the interior of the mandrel, so that the gas exiting through the gas outlet openings can flow via these discharge openings into the discharge channel in the interior of the mandrel and can be carried away there in the interior, preferably in the axial direction.

It is very particularly preferable if a temperature-control device is assigned to the mandrel or to the gas outlet openings, with which device the pressurised gas, in particular compressed air, which is applied to the gas outlet openings from the mandrel interior, can be adjusted, in particular regulated, in a defined manner, i.e. to a preselectable or preselected temperature or a preselectable or preselected temperature range.

It is particularly expedient if the gas can be heated with the aid of the temperature-control means to a temperature at which stresses in the preferably already welded tubular shape are reduced. For this purpose, the gas temperature should preferably lie above 80° C., but it should fall short of the melting point of the substrate material, in particular fall well short thereof. A preferred temperature range to which the compressed gases can be heated lies between 80° C. and 120° C. As a result of the aforementioned heating, material stresses, originating especially from the welding process, are reduced and the roundness of the tubular structure is thus improved. For this purpose, heated air can exit at the axial height of the welding means or downstream of the welding means through corresponding gas outlet openings in the mandrel. The tubular shape is preferably heated over a large area, in particular over its entirety, which can be guaranteed by the provision of the multiplicity of gas outlet openings.

In addition or as an alternative, the temperature-control means can be provided for cooling compressed air, for example in order to achieve rapid cooling of the weld region or the tubular shape previously heated over a large area or for the fixing a specially formed tubular shape.

It is very particularly preferable if the mandrel comprises at least two axial sections (chambers) preferably sealed off from one another, to which a compressed gas volume flow can be applied in each case, in particular independently of one another, wherein the temperature of at least one of the gas volume flows can be adjusted with the temperature-control means, preferably in such a way that air heated in a first axial section (first chamber), preferably from a temperature range between 80° C. and 120° C., can exit through gas outlet openings. Cooler gas can preferably exit through gas outlet openings provided in a second axial section (second chamber) of the mandrel, with the aim of bringing about cooling of the tubular shape, in particular of a weld seam produced with the aid of the welding means and/or of the tubular shape previously heated, as the case may be, over a large area in the first axial section. The cooled gas can for example be air at room temperature or air or another gas temperature-controlled in a defined manner with the aid of corresponding temperature-control means. The second axial section is preferably disposed downstream of the first axial section in the transport direction of the tubular shape.

The previously described development of the invention is not restricted to two axial sections. Thus, more than two axial sections chargeable separately with compressed gas can also be provided, wherein temperature-control means are preferably assigned to at least one of the axial sections. The temperature of at least two gas volume flows conveyed to different axial sections preferably differs.

The invention also leads to a method for producing tubular structures for packing tubes comprising a substrate, which is constituted in particular by a laminate material and which has a preferred thickness extension from a range between 75 μm and 500 μm. The substrate material generates increased friction, especially in a state shaped into a tubular shape, assisted by pressure-application means acting radially from the outside inwards on the substrate material. According to the invention, provision is made, in order to minimise this friction between the mandrel and the substrate material, to generate a gas cushion, in particular an air cushion, which is preferably characterised at least locally by pressures from a value range between 1 bar and 6 bar. For this purpose, compressed gas, in particular compressed air, is preferably pressed through microporous and/or nanoporous mandrel material into a region between the mandrel and the substrate material. In particular, a compressed gas volume flow of approx. 1 cm³ to 150 cm³/mm per cm² of mandrel surface is generated for this purpose through the pores. In contrast with extrusion processes for example, pressure-application means are essential in the production process for tubular structures, said pressure-application means on the one hand counteracting widening of the tubular shape and in particular avoiding floating of the tubular shape on the mandrel, this being assisted by welding strips clamping the substrate web, said welding strips taking up the substrate material between them in a sandwich-like manner, wherein the longitudinal edge regions of the substrate material either overlap or abut against one another in a region between the welding strips. Since, in contrast with extrusion processes, the substrate material is heated only in the welding region and is otherwise cold in the case of the production of tubular structures, the substrate material is comparatively rigid compared to fluid, molten plastic which is pressed through extrusion nozzles. A further essential difference with respect to extrusion processes is that the mandrel required for tubular structure production is much less rotation-symmetrical than the mandrels used in extrusion processes, this being necessary for example due to the provision of the welding strips, wherein at least an inner welding strip preferably runs in a longitudinal groove of the mandrel.

### BRIEF DESCRIPTION OF THE DRAWINGS

Further advantages, features and details of the invention emerge from the following description of preferred examples of embodiment and with the aid of the drawings. In the Figures:

FIG. 1 shows a plan view of a device for producing tubular structures in a diagrammatic representation,

FIG. 2 shows a mandrel constituted, at least in sections, by a microporous material,

FIG. 3 shows a detail representation of a mandrel constituted by microporous material with a tubular shape surrounding the latter, said tubular shape being subjected to a force radially from the outside inwards by means of a forming strap,

FIG. 4 shows a cross-sectional view according to FIG. 3, wherein concave-shaped rollers are shown here, with which the forming strap according to FIG. 3 is pressed in the radial direction inwards onto the tubular structure, in order thus to bring about a sufficient adhesive force between the forming strap and the tubular body, with which to transport tubular structures together with the forming strap with the aid of the rotating rollers in the direction of the longitudinal extension of the mandrel,

FIG. 5 shows a representation of alternative combined pressure-application and conveying means in the form of conveyor belts acting directly on the tubular structure and carrying along the tubular structure in the direction of the longitudinal extension of the mandrel, said conveyor belts being disposed radially outside a flattened portion of the mandrel,

FIG. 6 shows an alternative cross-sectional representation of a mandrel with an only partially represented longitudinal groove, in which a welding strip of welding means is disposed,

FIG. 7 shows a cross-sectional view through the mandrel according to FIG. 6 at the height of the longitudinal groove, wherein an energy source, here an HF source, for heating a welding region is disposed radially outside the longitudinal groove,

FIG. 8 shows a diagrammatic cross-sectional representation of a mandrel split up into two axial sections, which respectively can be acted upon independently of one another by a gas volume flow in each case, wherein the temperature of at least one of the gas volume flows can be adjusted, preferably regulated,

FIG. 9 shows a diagrammatic side view of a mandrel with a coating comprising porous, preferably foamed, material forming the gas outlet openings, wherein a plurality of gas discharge channels spaced apart uniformly in the circumferential direction and constituted as gas discharge grooves are provided in the mandrel surface,

FIG. 10 shows a very diagrammatic longitudinal cross-sectional view of a possible variant of the mandrel embodiment, wherein gas exiting through the pores of porous material can flow away via larger discharge openings radially inwards into the mandrel and there into an inner gas discharge channel in the axial direction, and

FIG. 11 shows a cross-sectional view through a possible variant of embodiment of a mandrel, wherein a coating of a porous, in particular foamed, material is provided for example with metal or ceramic on a supporting structure, wherein the supporting structure comprises a multiplicity of supply grooves for compressed gas disposed beside one another in the circumferential direction and running in the axial direction, said supply grooves ensuring an at least approximately uniform distribution of the gas flow. If need be, the shown variant of embodiment can be combined with a discharge opening for the discharge of gas in the interior of the mandrel and/or with gas discharge channels, for example in the form of gas discharge grooves, provided at the external periphery.

Identical elements and elements with the same function are designated by the same reference numbers in the Figures.

### DETAILED DESCRIPTION

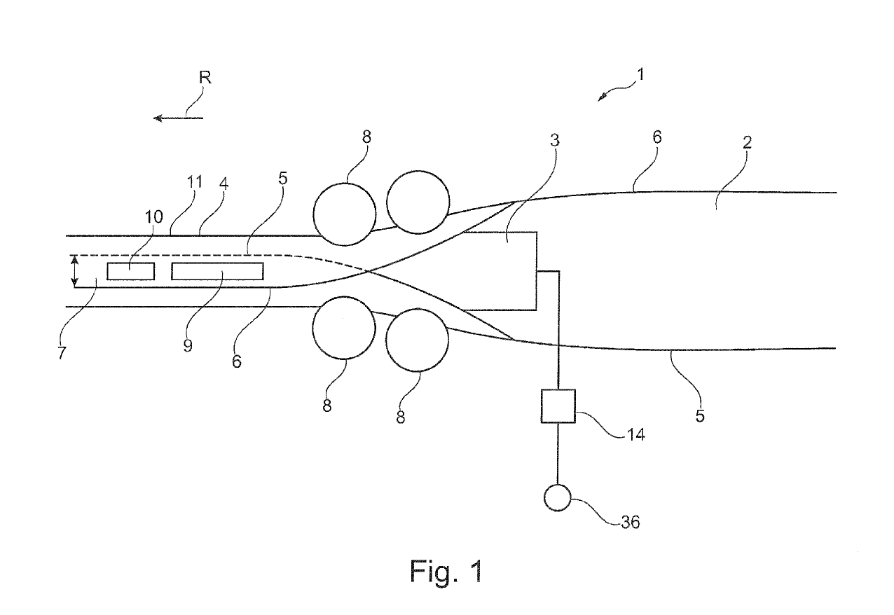

FIG. 1 shows in a plan view a device 1 for producing tubular pipes for packaging tubes. In the shown section of the device, a flat, initially web-like, for example single- or multi-layered, substrate 2 is shaped around a, in this case, cylindrical mandrel 3 into a tubular shape 4, which comprises an overlapping region 7 formed between two longitudinal edges 5, 6, said overlapping region being formed by two longitudinal edge regions of substrate 2. The formed pipe is cut into tubular pipes of desired length in a region located farther downstream in transport direction R (not represented).

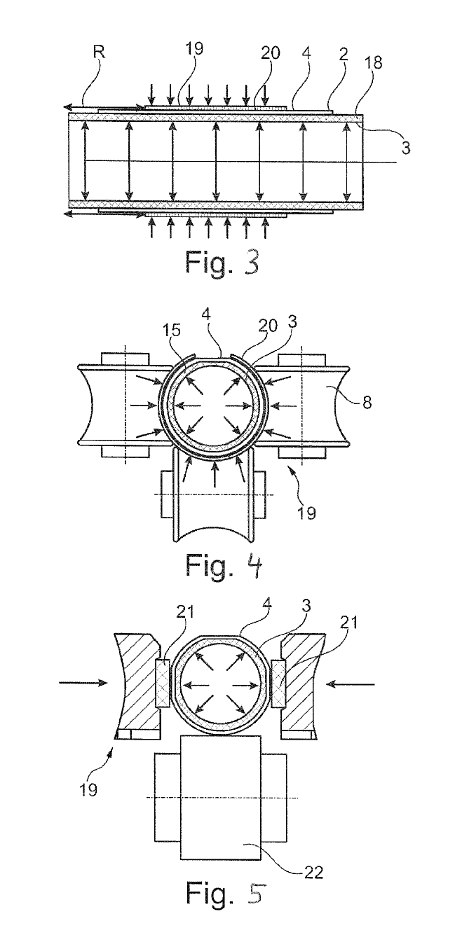

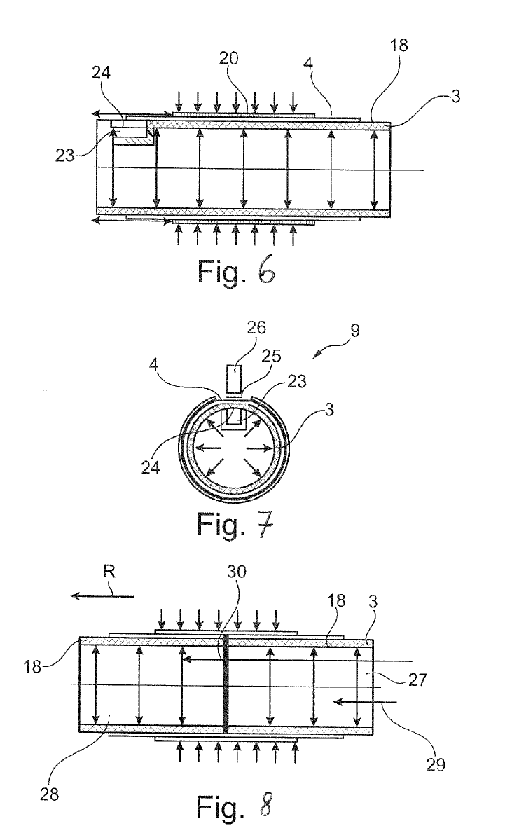

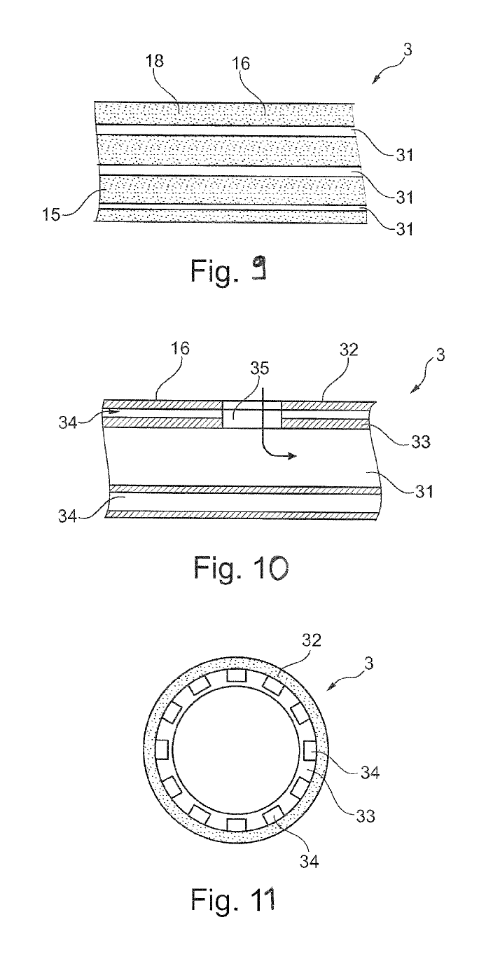

Assigned to substrate 2 are transport rollers (not represented), with which substrate 2 is transported in the direction of mandrel 3 in transport direction R. The shaping takes place with the aid of concave-contoured rollers 8 (combined pressure-application and conveying means 19), which shape the substrate out of the flat web shape into tubular shape 4, which tightly surrounds mandrel 3 and is transported along by the latter in transport direction R onward to the aforementioned cutting device (not represented). Rollers 8 can act, as represented, directly on the tubular shape or via at least one forming strap not represented for reasons of clarity, but shown for example in FIGS. 3 and 4. It is essential that the substrate is pressed radially inwards in the direction of mandrel 3 in order to prevent floating of the substrate and the tubular shape formed therefrom on the mandrel.

Located downstream of rollers 8 in transport direction R are welding means 9, for example a high-frequency welding device, for welding overlapping region 7, more precisely for welding the overlapping longitudinal edge regions of substrate 2, or more precisely of tubular shape 4. Located downstream thereof in transport direction R are pressure-application means 10 for solidifying or pressing weld seam 11 produced with the aid of welding means 9.

Located downstream of pressure-application means 10 in the transport direction are cooling means in the prior art (not represented) for cooling the hot weld seam from the welding process, the cooling means preferably being dispensed with in a development of the invention, since the cooling function can be taken over by compressed gas exiting from gas outlet openings to be explained in greater detail below.

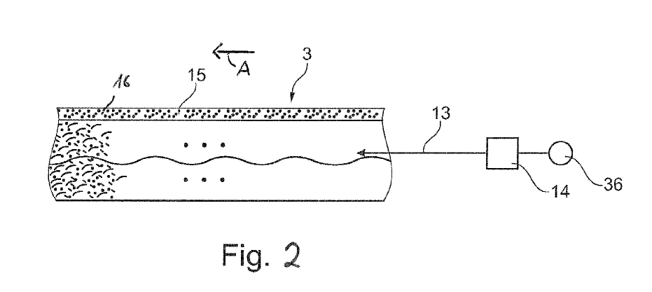

In order to reduce the friction between substrate 2, more precisely tubular shape 4, and mandrel 3, mandrel 3 is provided with a multiplicity of gas outlet openings not shown in FIG. 1, through which a gas, in particular compressed air, can be blown out radially from the inside outwards in order to form a preferably uniform air cushion between substrate 2, more precisely tubular shape 4, and mandrel 3. Different variants of embodiment of the gas outlet openings emerge by way of example from FIGS. 2 and 3.

It can be seen from FIG. 1 that compressed gas is fed via a compressed gas line to the mandrel—this compressed gas exits from the gas outlet openings located in the mandrel surface in order to form a gas cushion. The compressed gas is conveyed from a compressed gas source 36 via temperature-control means 14 to the mandrel interior.

FIG. 3 shows a detail of a mandrel 3 for a device 1 according to FIG. 1, wherein mandrel 3 is represented a cross-section in the upper region. Arrow direction 13 indicated with reference number 13 symbolises the gas supply, here the compressed air supply, in the interior of mandrel 3, wherein the compressed air is conveyed through temperature-control means 14, which in the shown example of embodiment are constituted by flow heaters, wherein compressed air can alternatively also be conveyed from heated compressed air containers. Temperature-control means 14 constituted as heating means heat the compressed air to a preferred temperature from a value range between 80° C. and 120° C., in order to remove stresses in the substrate material and thus to improve the roundness of the tubular shape.

In the example of embodiment according to FIG. 2, a multiplicity of gas outlet openings 15 are disposed both behind one another in an axial direction A more or less coinciding with the transport direction, as well as beside one another in the circumferential direction, wherein gas outlet openings 15 are disposed directly in curved mandrel surface 16 of mandrel 3, constituted as a lateral cylindrical surface, and not offset radially inwards with respect to the latter.

In the example of embodiment according to FIG. 2, the mandrel is constituted at least in sections by a porous material 18 (e.g. polished metal foam), which comprises a multiplicity of gas outlet openings 15 constituted by micropores, which are disposed beside one another both axially and in the circumferential direction, in such a way that an air cushion is thus ensured. The compressed air is also conveyed through optional heating means 14 in the case of the example of embodiment according to FIG. 2.

FIG. 3 shows a longitudinal cross-section of a mandrel 3 in an alternative representation. The latter is internally hollow and can be acted on with compressed gas, in particular compressed air, wherein the compressed gas migrates through microporous mandrel material 18 in the radial direction outwards. The microporous material is preferably a metal foam, for example an aluminium foam, which if need be is provided with stabilisation additives. With the aid of the compressed gas, an air cushion is formed between tubular shape 4 formed from a substrate 2 and mandrel 3. Tubular shape 4 is transported in transport direction R with the aid of combined pressure-application and conveying means 19, which in the shown example of embodiment comprise a forming strap 20, which is pressed radially inwards against tubular shape 4 in order thus to generate static friction between forming strap 20 and flexible tubular shape 4, so that tubular shape 4 is carried along by forming strap 20 in axial transport direction R.

In the example of embodiment shown, porous material 18 is constituted self-supporting, i.e. does not comprise any additional supporting structure. In an alternative variant of embodiment (not represented), microporous material 18 is applied on a supporting structure, which is formed for example by a cylindrical perforated plate.

Instead of microporous material 18, it is possible to provide, at least in sections, in a nanoporous material. It is also conceivable to provide nanoporous material on microporous material, so that the pore size of the mandrel material overall diminishes radially from the inside outwards.

FIG. 4 shows a cross-sectional view through FIG. 3, wherein concave rollers 8 not shown in FIG. 3 for reasons of clarity are represented, which apply a force from radially outwards on forming strap 20 of combined pressure-application and conveying means 19. Mandrel 3 made of microporous material can also be seen, in which a multiplicity of, preferably several thousand, gas outlet openings 15 (here pores)) are formed, through which compressed gas can exit radially from the inside outwards in order to form an air cushion between tubular shape 4 and mandrel 3.

FIG. 5 shows in a cross-sectional view alternatively constituted pressure-application and form-fitting means 19. In the example of embodiment shown, the latter comprise two conveyor belts 21 disposed in parallel, which are driven and which, again on account of the friction effect, transport tubular shape 4 in the transport direction, i.e. into the plane of the drawing. Conveyor belts 21 are pressed inwards in the radial direction in order to ensure the necessary static friction. In addition to the two conveyor belts 21, a support roller 22 is provided, which supports tubular shape 4 in a lower region. Support roller 22 can also be constituted as a drive roller.

FIG. 6 shows a mandrel made of porous material 18, wherein a longitudinal groove 23 represented only as a detail is provided, in which an (inner) welding strip 24 is disposed, which during operation lies radially inwards adjacent to the tubular shape, in particular in an overlapping region 7, wherein the tubular shape is taken up sandwich-like by inner welding strip 24 and a further outer welding strip (not represented) (see FIG. 7) and is then acted upon with welding energy, for example high-frequency radiation.

FIG. 7 shows a cross-sectional view through mandrel 3 at the height of longitudinal groove 23 with (inner) welding strip 24 disposed therein. An outer welding strip 25 is provided parallel to this inner welding strip 24 running along with the tubular shape, wherein the two welding strips 24, 25 take up tubular shape 4 sandwich-like between them in a welding region. An HF source 26 of welding means 9 is also shown outside the outer welding strip 25.

FIG. 8 shows a further alternative embodiment of mandrel 3 in a longitudinal cross-sectional view. The mandrel is split up into to axial sections, i.e. a first axial section 27 and a second axial section 28, which are sealed off against one another, so that the axial sections each constituted by porous material 18 can be acted upon separately in each case with a compressed gas volume flow. The first gas volume flow for acting upon the first axial section is indicated by reference number 29 and is represented only diagrammatically as an arrow. The second gas volume flow is indicated by reference number 30 and is conveyed for example via a pipeline to second axial section 28, in particular in the interior of mandrel 3.

It is very particularly preferable if the two gas volume flows 29, 30 have a temperature different from one another, wherein it is further preferable if first axial section 27 disposed upstream of the second axial section in transport direction R is acted on by a first gas, in particular means of applying pressure, having a higher temperature than the second gas volume flow, in order to generate to differently temperature-controlled air cushions, wherein tubular shape 4 is heated with the first air cushion radially outside the first axial section, preferably to a temperature from a temperature range between approx. 80° C. and approx. 120° C., in order thus to remove stresses from the material, wherein tubular shape 4 is preferably cooled with the second, axially adjacent air cushion. The temperature control of the first gas volume flow takes place with the aid of temperature-control means comprising, for example, a heat exchanger (not represented).

FIG. 9 shows a section of mandrel 3 from the exterior. It can be seen that convex-curved mandrel surface 16 is constituted by a porous material 18, in particular a metal foam, a ceramic foam or a plastic foam, for example a polyurethane foam. A plurality of gas discharge channels 31, preferably spaced apart uniformly in the circumferential direction, is provided in the surface in the form of axial grooves (gas discharge grooves). The compressed gas exiting through gas outlet openings 15 constituted as pores can flow out in the radial direction through these gas discharge channels 31, as a result of which undesired swelling of the tubular shape is avoided.

FIG. 10 shows, in a very diagrammatic view, an alternative variant of embodiment of a mandrel 3 in a longitudinal cross-sectional view. An outer coating 32 comprising a porous material 16 can be seen.

This porous coating 32 with its gas outlet openings formed by pores is supported by a supporting structure 33, in which a plurality of gas supply channels 34 spaced apart in the circumferential direction are provided, said gas supply channels distributing the inflowing compressed gas uniformly. Formed in the interior of mandrel 3 is a gas discharge channel 31, which is connected to a region between the tubular shape and mandrel surface 16 via at least one radially extending discharge opening 35, via which excess compressed gas can flow inwards into gas discharge channel 31 and axially away in the latter.

FIG. 11 shows diagrammatically a cross-sectional view of an alternative variant of the mandrel embodiment. A coating 32 of porous materials can be seen, which forms the gas outlet openings in the form of pores. Coating 32 can be constituted single-layered, for example of microporous or nanoporous material, or multi-layer, wherein for example a nanoporous outer layer is deposited or provided on a microporous inner layer. In the example of embodiment shown, the total thickness extension of coating 32 amounts to 2 mm. Coating 32 is supported by a supporting structure 33, which comprises a multiplicity of gas supply channels 34 constituted by longitudinal grooves, which ensure a uniform air distribution. If need be, the inner region, i.e. the region inside supporting structure 33, can be used as a gas discharge channel, into which air is supplied via at least one discharge opening from mandrel surface 16.

1-15. (canceled)

16. A device for producing tubular structures for packaging tubes, comprising an elongated mandrel extending in an axial direction, around which a substrate web can be shaped to produce a tubular shape, the mandrel is provided with a plurality of gas outlet openings for receiving compressed gas to generate a gas cushion between the mandrel and the tubular shape, welding means for welding the tubular shape, combined pressure-application and conveying means disposed radially adjacent to the mandrel for pressing the tubular shape radially inwards in a direction of a mandrel surface of the mandrel, the mandrel surface being convex-curved in the circumferential direction, and the tubular shape is transported in the direction of the longitudinal direction of the mandrel by means of a friction effect between the pressure-application and conveying means and the tubular shape, and wherein the mandrel surface is constituted, at least in sections, by a microporous and/or nanoporous material which form the gas outlet openings in the form of pores, and that the gas outlet openings are constituted such that the generated gas cushion counteracts the pressure-application force of the combined pressure-application and conveying means.

17. The device according to claim 16, wherein at least 10 gas outlet openings are disposed at different axial positions along the axial extension of the mandrel and at least 10 gas outlet openings are disposed at different circumferential positions along the circumferential extension of the mandrel.

18. The device according to claim 16, wherein, in at least one surface section, at least 5 gas outlet openings are provided per cm² of mandrel surface.

19. The device according to claim 16, wherein at least some of the gas outlet openings are provided in a lateral cylindrical surface of the mandrel.

20. The device according to claim 16, wherein a majority of the gas outlet openings are provided in a lateral cylindrical surface of the mandrel.

21. The device according to claim 16, wherein all of the gas outlet openings are provided in a lateral cylindrical surface of the mandrel.

22. The device according to claim 16, wherein a longitudinal groove is disposed in the mandrel in which a welding strip is accommodated.

23. The device according to claim 16, wherein the substrate web comprises a porous material selected from the group consisting of a sintered material, a material produced by thermal spraying, a metal foam, a plastic foam, and a ceramic foam.

24. The device according to claim 16, wherein the average pore size of the pores is selected from a value range between 0.05 μm and 2 mm.

25. The device according to claim 16, wherein the average pore size of the pores is selected from a value range between 0.1 μm and 1.0 mm.

26. The device according to claim 16, wherein the average pore size of the pores is selected from a value range between 1 nm and 100 nm.

27. The device according to claim 16, wherein temperature-control means are provided for the defined heating and/or cooling temperature of the compressed gas.

28. The device according to claim 27, wherein the compressed gas temperature is regulated by the temperature-control means to a temperature range between 80° C. and 120° C., at which temperature material stresses of the tubular shape are reduced.

29. The device according to claim 28, wherein the mandrel comprises a first axial section comprising gas outlet openings to which a gas volume flow is applied having a first temperature is regulated by means of the temperature-control means, and a second axial section to which a second gas volume flow is applied having a second temperature different from the first temperature and is regulated by means of the temperature-control means.

30. The device according to claim 29, wherein the first axial section is disposed upstream of the second axial section in the transport direction of the tubular casing, and the second temperature is lower than the first temperature by at least 10° C.

31. The device according to claim 29, wherein the first axial section is disposed upstream of the second axial section in the transport direction of the tubular casing, and the second temperature is lower than the first temperature by at least 20° C.

32. The device according to claim 29, wherein the first axial section is disposed upstream of the second axial section in the transport direction of the tubular casing, and the second temperature is lower than the first temperature by at least 30° C. or 40° C.

33. The device according to claim 29, wherein the first axial section is disposed upstream of the second axial section in the transport direction of the tubular casing, and the second temperature is selected from a temperature range between 10° C. and 75° C.

34. A method for producing tubular structures for packaging tubes, comprising the steps of:
shaping a substrate web, constituted as a multi-layered laminate web around an elongated mandrel extending in an axial direction to form a tubular shape, welding the tubular shape, pressing the tubular shape radially inwards in a direction of a mandrel surface of a mandrel surface of the mandrel, the surface being convex-curved in the circumferential direction, transporting the tubular shape in the direction of a longitudinal direction of the mandrel, and feeding a compressed gas between the mandrel and the tubular shape to generate a gas cushion, wherein the compressed gas is conveyed through gas outlet openings constituted by pores in a microporous and/or nanoporous material forming the curved mandrel surface, at least in sections, and the generated gas cushion counteracts a pressure-application force of a combined pressure-application and conveying means.

35. The method according to claim 34, wherein the gas cushion, at least in a partial section, is generated with a radial extension between 3 μm and 50 μm.

36. The method according to claim 34, including conveying the compressed gas with a volume flow between 1 cm³ and 50 cm³ per cm² to produce a pressure in the gas cushion of between 1 bar and 6 bar.

37. The method according to claim 34, including pressing the tubular shape radially inwards in such a way that a gas cushion inhomogeneous in respect of its radial extension is generated.
